(19) United States
(12) Patent Application Publication
(10) Pub. No.: US 2009/0046116 A1
(43) Pub. Date: Feb. 19, 2009

(54) PRINT ARCHITECTURE FOR DRIVING MULTIPLE PRINT HEADS

(75) Inventors: Brad L. Davies, Derby, CT (US); Elaine B. Cristiani, Stratford, CT (US); Keith M. Smith, Fairfield, CT (US); Wesley A. Kirschner, Farmington, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/967,887

(22) Filed: Dec. 31, 2007

Related U.S. Application Data
(60) Provisional application No. 60/955,900, filed on Aug. 15, 2007.

(51) Int. Cl. B41J 29/38

(52) U.S. Cl. 347/9

(57) ABSTRACT

A system architecture is provided for a fixed-head mailpiece printer. The printer includes at least two laterally and longitudinally-spaced print heads for depositing ink on a face surface of a mailpiece. The print system architecture includes print application software or software program code operative to render print image data into a plurality of logical rectangular bitmap print buffers. Further, a field programmable gate array (FPGA) remaps each of the logical rectangular bitmap print buffers into one of the print heads based upon its spatial position relative to the mailpiece. Furthermore, the FPGA is operative to control the deposition of ink from the print heads based upon the print image data contained in the print buffers. Moreover, the FPGA minimizes processing time associated with print image rendering to achieve enhanced print system throughput.

### CROSS REFERENCE TO RELATED APPLICATIONS

This application claims priority under 35 USC §119(3) from Provisional Patent Application Ser. No. 60/955,900, filed Aug. 15, 2007, entitled PRINT ARCHITECTURE FOR DRIVING MULTIPLE PRINT HEADS (Attorney Docket Number G-359), which is incorporated herein by reference in its entirety.

### TECHNICAL FIELD

The present invention relates to computer software for controlling the deposition of ink through print head nozzles, and more particularly, to a new and useful print architecture for driving multiple print heads.

### BACKGROUND OF THE INVENTION

In-line printers for mailpiece creation, i.e., the printing of a destination address, return address and postage indicia, typically employ multiple print heads to print along dedicated “zones” on the face of a mailpiece envelope. Commonly, a plurality of microprocessors are employed, i.e., one for each print head, to control the deposition of ink from each of the print head nozzles. This configuration introduces additional memory requirements and is costly to implement, both from a hardware and software perspective.

Field Programmable Gate Arrays (FPGAs) and Application Specific Integrated Circuits (ASICs) are known to provide additional flexibility and processing speed due to the programmable nature of these processors. FPGAs are programmable and new code can be downloaded whenever a change to software instructions are needed. ASICs are generally produced as specific or dedicated integrated circuits based upon well-developed code and can offload many of the commands typically processed in software. These devices, when used in conjunction with software applications, can dramatically increase processing speed and throughput.

A need exists for a robust print system architecture which increases system throughput via the integration of an FPGA to drive multiple print heads in a fixed-head print system while optimizing system cost.

### SUMMARY OF THE INVENTION

A system architecture is provided for a fixed-head mailpiece printer. The printer includes at least two laterally and longitudinally-spaced print heads for depositing ink on a face surface of a mailpiece. The print system architecture includes print application software or software program code operative to render print image data into a plurality of logical rectangular bitmap print buffers. Further, a field programmable gate array (FPGA) remaps each of the logical rectangular bitmap print buffers into one of the print heads based upon its spatial position relative to the mailpiece. Furthermore, the FPGA is operative to control the deposition of ink from the print heads based upon the print image data contained in the print buffers. Moreover, the FPGA minimizes processing time associated with print image rendering to achieve enhanced print system throughput.

### BRIEF DESCRIPTION OF THE DRAWINGS

The accompanying drawings illustrate a presently preferred embodiment of the invention and, together with the general description given above and the detailed description given below, serve to explain the principles of the invention. As shown throughout the drawings, like reference numerals designate like or corresponding parts.

FIG. 1 is a diagram of the system architecture of the present invention including the software and hardware employed therein wherein the software program code (i.e., the printer application) interfaces with a processor and Field Programmable Gate Array (FPGA) to drive a plurality of print heads of a fixed head mailpiece printer.

FIG. 2 is a diagram of the software architecture employed in the present invention including the interaction between the print manager, FPGA, printer sensors and object rendering software.

FIG. 3 is a diagram of the print operations controlled by the system architecture including the interaction between the print manager, print driver, print heads, direct memory access (DMA) and print buffers.

FIG. 4 is a flow diagram of the error handling software for addressing errors which may occur during print operations.

### BEST MODE TO CARRY OUT THE INVENTION

The inventive print system architecture and control algorithms therefor are described in the context of a fixed-head printer having two (2) banks of three print heads, though the inventive system architecture may be used in combination with any fixed head printer having at least two (2) longitudinally and/or laterally-spaced print heads.

The system architecture is operative to control a fixed-head mailpiece printer having laterally and longitudinally-spaced print heads. The print heads deposit ink on a face surface of the mailpiece in zones or regions of print. For example, one zone nearest the top edge of the mailpiece envelope may print a portion of the return address, a two-dimensional bar code image and a portion of the postage indicia for mailpiece delivery. A second zone, immediately below the first zone, may include the remainder of the return address, postage indicia and a portion of the destination address. Finally, a third zone, immediately below the second zone, may be associated with the remainder of the destination address. Generally, each print head and/or print head nozzle is dedicated to printing within a particular rectangular region or zone.

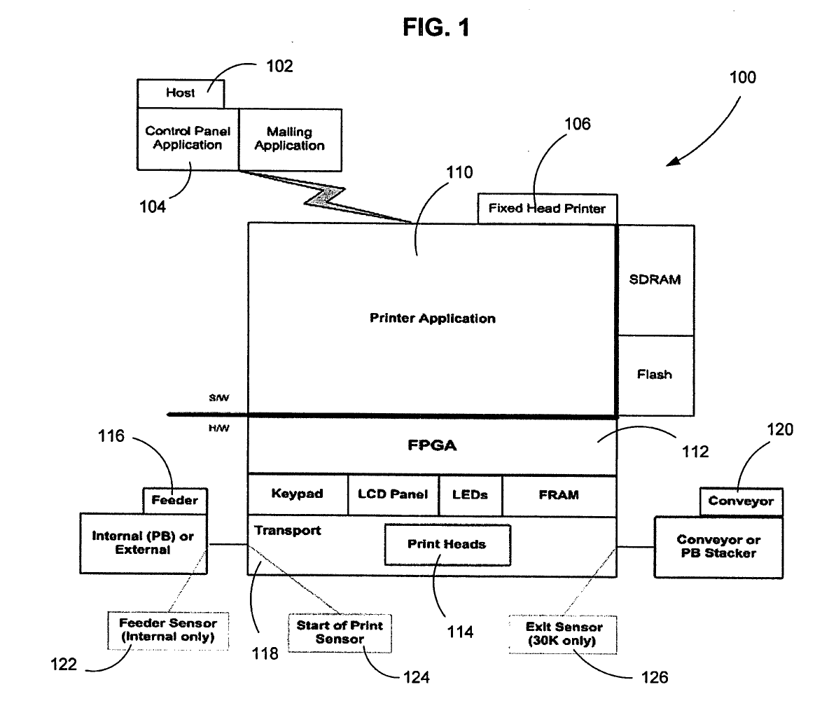

In FIG. 1, the system architecture 100 of the present invention includes a host PC 102 for running a driver/control panel 104 for a printer 106. Software program code 110, (hereinafter “the printer application”), is operative to control the printer 106 and generate print image data for printing on a mailpiece envelope (not shown in FIG. 1). The printer application 110 runs on a Renesas microprocessor which interfaces with a Field Programmable Gate Array (FPGA) 112 to drive a plurality of print heads 114 of the fixed-head printer 106. The FPGA 112 performs combing operations and manages the interaction between the multiple print heads 114 by passing the rendered print image data to each of the print heads 114.

Furthermore, the FPGA 112 is generally operative to control the various software and hardware functions including the operation of a feeder 116, speed of a mailpiece conveyance or transport device 118, a mailpiece stacker 120, the operation of various print operation sensors 122, 124, 126, and the operation of at least one compare match timer. The print operation sensors may include a feeder sensor 122 to monitor the feeder 116, a Start of Print (SOP) sensor 122 to indicate when print should begin and an Exit Sensor 124 to detect when the mailpiece envelope exits the transport.

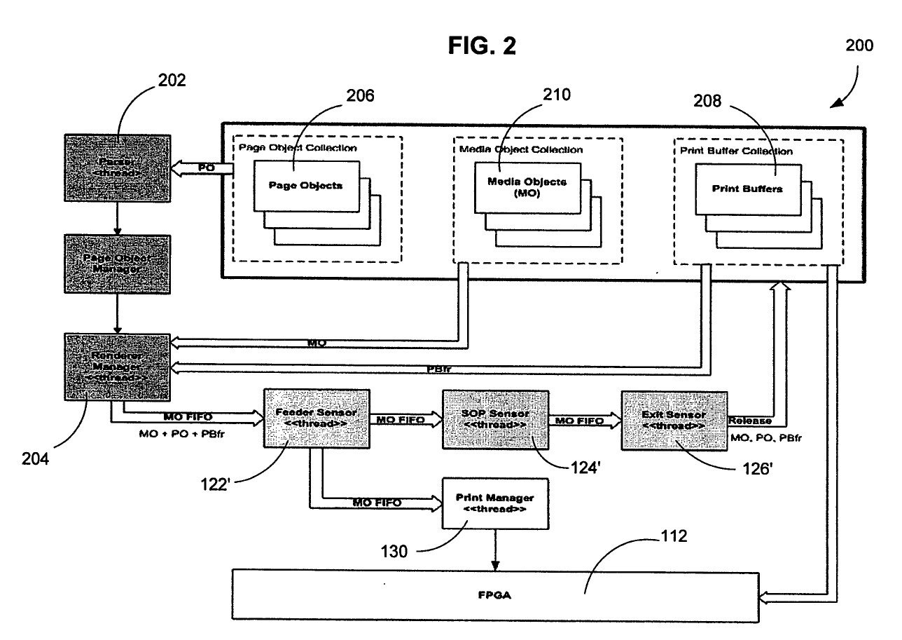

In FIG. 2, the system architecture 100 of the present invention includes a Parser 202 and a Renderer 204 as shown in the block diagram of the software architecture 200. The parser takes the printer control language (PCL) and forms page objects 206. These objects define the elements of a page, i.e., margins, fonts, text, and graphics. The Renderer 204 takes the page objects 206 and forms a bit map image. The rendered image is then placed in a print buffer 208 which does not map to a print head, but maps to a page. Thereafter, a media object 210 is then loaded with information and contains the attributes of the print image including a pointer to the print buffer. The media object then flows through the Feeder Sensor, SOP Sensor, and Exit Sensor threads 122′, 124′, 126′ which are integrated within the system. However, the media object 210 can be on multiple queues and the sensor events can cause the state to transition. Further, the Print Manager 130 contains the media object 210 and controls the printing. Moreover, the media object 210 provides a virtual model of paper flow through the printer 106 such that tracking and error recovery can occur.

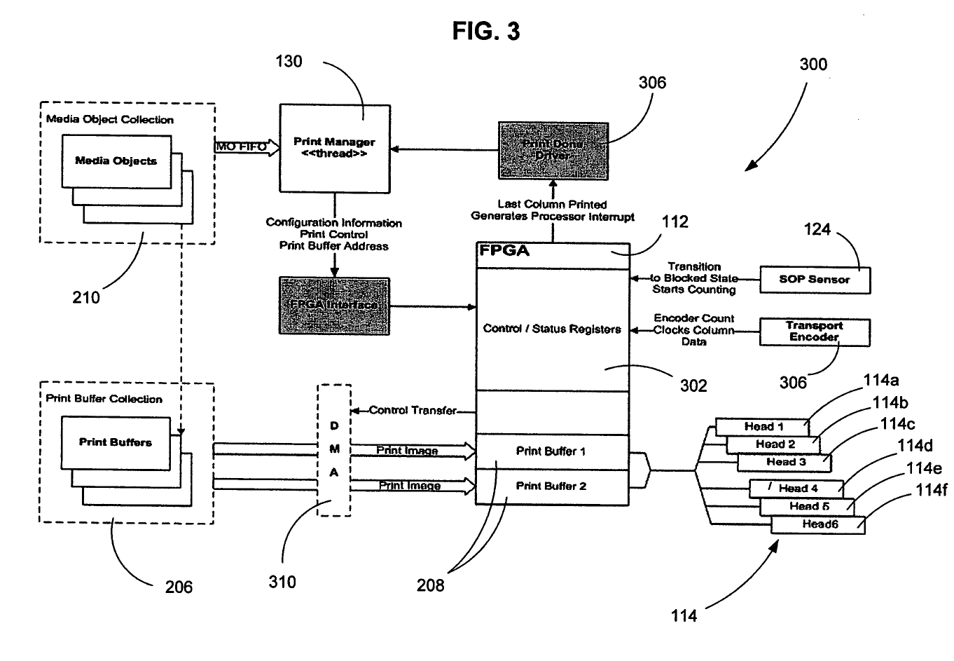

In FIG. 3, a diagram of the print operations 300 shows the print manager 130 receiving a media object in its queue. The print manager interfaces 130 with the FPGA 112 to determine whether the FPGA 112 can accept a buffer 208 for use by a control register 302. When ready, the FPGA 112 employs a Dynamic Memory Allocation controller 304 to send the print buffer 208 into the memory of the FPGA 112. The FPGA 112 will then prepare/comb the print image data and perform bitwise operations on the data. This enables image rendering to be split or shared between the system software and hardware elements of the system architecture. Additionally, the spacing between the nozzles of the print head 114 and the distances therebetween are used by the FPGA 112 to correctly print the image. Once the mailpiece or envelope passes the Start of Page (SOP) sensor 124, the FPGA 112 receives clock or count signals from an encoder 306 to fire the nozzles on multiple heads 114a-114f as needed to generate the printed image. When a last column of the buffered data is printed (associated with any one of the print heads), the FPGA 112 sends a Print Done Interrupt signal 310 back to the processor/print manager 130. The processor 110 can then clear the print buffer 208 and release data for the next mail piece.

It should be appreciated that the FPGA 112 may have more than one buffer 208 available to accept print image data from the processor 110. The buffers 208 are needed so that the software can load print data while printing of the previous mailpiece is completed. In the described embodiment, the FPGA 112 employs three buffers 208.

In an alternate embodiment of the invention, an exit sensor 126 is not employed. In this embodiment, the software employs a Compare Match Timer (not shown) in the FPGA 112 to simulate an exit sensor. That is, a time quantum based on the speed of the paper, i.e., speed of the transport 118, is used to provide an indication that paper has exited the transport. As an aside, the Compare Match Timer is not a timer, but contains a database of target values which are compared against a respective motor encoder (i.e., associated with the feeder or transport). The target values are loaded and matched against actual encoder values for use by the FPGA 112.

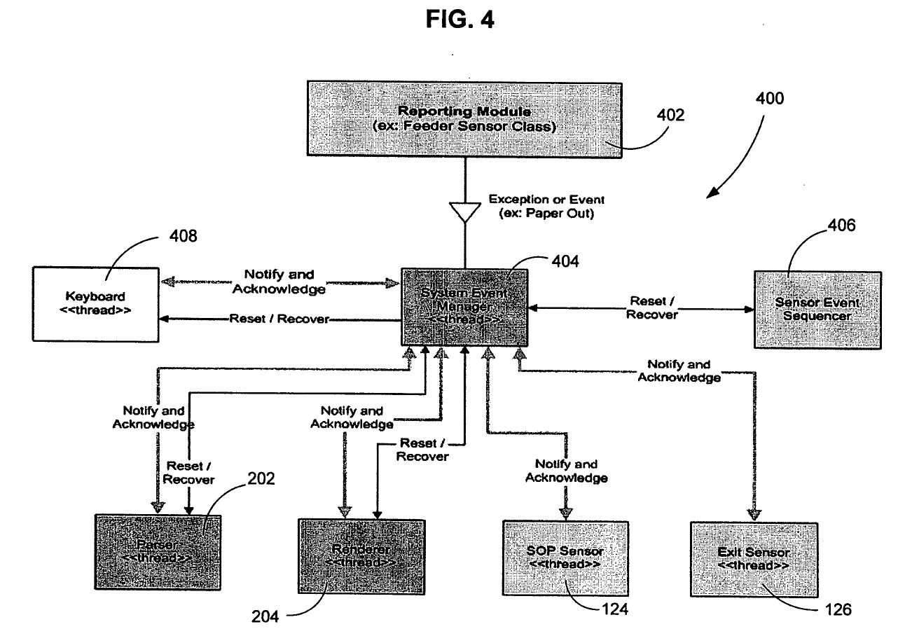

The system architecture 100 also identifies and corrects errors such as an “ink-out” condition and/or paper jam. In FIG. 4, the error handling software architecture 400 is depicted. Therein, a reporting module 402 interfaces with a system event manager 404 to reset and recover from various error events. The system event manager 404 is operatively coupled to an event sequencer 406, the SOP sensor 124, Exit Sensor 126, the parser 202, the renderer 204, and a keyboard 408. Each of the system elements either sends a notification/acknowledgement that an event has occurred.

In summary, the system architecture 100 of the present invention employs a single microprocessor 110 and an FPGA 112 to drive multiple print heads. This architecture reduces system cost while enhancing throughput. The software program code 110 is operative to render print image data into a plurality of logical rectangular bitmap print buffers and is decoupled from the FPGA 112. Thereafter, the FPGA 112 remaps each of the logical bitmap print buffers into one of the print heads based upon its spatial position relative to the mailpiece. Furthermore, the FPGA 112 is operative to control the deposition of ink from the print heads 114 based upon the print image data contained in the print buffers. As such, the FPGA 112 minimizes processing time associated with print image rendering to achieve enhanced print system throughput. Moreover, the FPGA can process multiple pages/mailpieces concurrently on a printer having two banks of print heads 114. This also increases system throughput. Additionally, the FPGA 112 also performs combing operation associated with each of the print heads.

It is to be understood that the present invention is not to be considered as limited to the specific embodiments described above and shown in the accompanying drawings. The illustrations merely show the best mode presently contemplated for carrying out the invention, and which is susceptible to such changes as may be obvious to one skilled in the art. The invention is intended to cover all such variations, modifications, and equivalents thereof as may be deemed to be within the scope of the claims appended hereto.

1. A system architecture for a fixed-head mailpiece printer, the printer having at least two laterally and longitudinally-spaced print heads for depositing ink on a face surface of the mailpiece, comprising:
software program code operative to render print image data into a plurality of logical rectangular bitmap print buffers; and,
a field programmable gate array operative to remap each of the logical rectangular bitmap print buffers into one of the print heads based upon its spatial position relative to the mailpiece, the FPGA furthermore operative to control the deposition of ink from the print heads based upon the print image data contained in the print buffers,
wherein the field programmable gate array minimizes processing time associated with print image rendering to achieve enhanced print system throughput.

2. The system architecture according to claim 1 wherein the field programmable gate array is operative to control a feeder for feeding mailpiece envelopes, a device for transporting envelopes to the print heads and a stacker for collecting the envelopes following print operations.

3. The system architecture according to claim 1 wherein the field programmable gate array controls the print heads to simultaneously print at least two longitudinally-spaced mailpieces.

4. The system architecture according to claim 1 wherein the field programmable gate array additionally performs combing functions associated with each of the print heads.

5. The system architecture according to claim 2 further comprising a print completion means for determining when print operations has been completed with respect to a mailpiece.

6. The system architecture according to claim 5 wherein the print completion means includes an exit sensor.

7. The system architecture according to claim 5 wherein the print completion means includes a compare match timer.

8. The system architecture according to claim 1 further comprising a dynamic memory allocation controller, wherein the size of the print buffers employed in the field programmable data array is determined by the dynamic memory allocation controller.

9. The system architecture according to claim 1 wherein the field programmable data array includes at least three print buffers.

10. The system architecture according to claim 5 further comprising a dynamic memory allocation controller, wherein the size of the print buffers employed in the field programmable data array is determined by the dynamic memory allocation controller.

11. The system architecture according to claim 5 wherein the field programmable data array includes at least three print buffers.

12. The system architecture according to claim 7 further comprising a dynamic memory allocation controller, wherein the size of the print buffers employed in the field programmable data array is determined by the dynamic memory allocation controller.

13. The system architecture according to claim 7 wherein the field programmable data array includes at least three print buffers.
